(19) United States
(12) Patent Application Publication
(10) Pub. No.: US 2010/0124672 A1
(43) Pub. Date: May 20, 2010

(54) GRANULAR PERPENDICULAR MEDIA WITH CORROSION-RESISTANT CAP LAYER FOR IMPROVED CORROSION PERFORMANCE

(75) Inventors: Raj Thangaraj, Fremont, CA (US); Charles F. Brucker, Pleasanton, CA (US); Huan Tang, Los Altos, CA (US); Jing Gui, Fremont, CA (US)

Correspondence Address: Shumaker & Sieffert, P.A., 1625 Radio Drive, Suite 300, Woodbury, MN, 55125, US

(73) Assignee: Seagate Technology LLC, Scotts Valley, CA (US)

(21) Appl. No.: 12/272,467

(22) Filed: Nov. 17, 2008

(51) Int. Cl. G11B 5/82; B05D 5/00; B32B 9/00

(52) U.S. Cl. 428/833.1; 427/131; 428/834; G9B/5.293

(57) ABSTRACT

A perpendicular magnetic recording media having an amorphous corrosion-resistant cap layer is disclosed. Preferably, the cap layer is a chromium alloy comprising Pt and C. A method of manufacturing the media is also disclosed.

### BACKGROUND

Magnetic disks and disk drives are employed for storing data in magnetizable form. Preferably, one or more disks are rotated on a central axis in combination with data transducing heads positioned in close proximity to the recording surfaces of the disks and moved generally radially with respect thereto. Magnetic disks are usually housed in a magnetic disk unit in a stationary state with a magnetic head having a specific load elastically in contact with and pressed against the surface of the disk. Data are written onto and read from a rapidly rotating recording disk by means of a magnetic head transducer assembly that flies closely over the surface of the disk. Preferably, each face of each disk will have its own independent head.

Magnetic thin-film media, wherein a fine grained polycrystalline magnetic alloy layer serves as the active recording medium layer, are generally classified as “longitudinal” or “perpendicular,” depending on the orientation of the magnetic domains of the grains of the magnetic material. FIG. 1 shows a disk recording medium and a cross section of a disc showing the difference between longitudinal and perpendicular recording.

Perpendicular recording media are being developed for higher density recording as compared to longitudinal media. The thin-film perpendicular magnetic recording medium comprises a substrate and a magnetic layer having perpendicular magnetic anisotropy, wherein the magnetic layer comprises an easy axis oriented substantially in a direction perpendicular to the plane of the magnetic layer. Typically, the thin-film perpendicular magnetic recording medium comprises a rigid NiP-plated Al alloy substrate, or alternatively a glass or glass-ceramic substrate, and successively sputtered layers. The sputtered layers can include one or more underlayers, one or more magnetic layers, and a protective overcoat. The protective overcoat is typically a carbon overcoat which protects the magnetic layer from corrosion and oxidation and also reduces frictional forces between the disc and a read/write head. In addition, a thin layer of lubricant may be applied to the surface of the protective overcoat to enhance the tribological performance of the head-disc interface by reducing friction and wear of the protective overcoat.

Granular perpendicular recording media are being developed for its capability of further extending the areal recording density as compared to conventional perpendicular recording media which are limited by the existence of strong exchange coupling between magnetic grains. In contrast to conventional perpendicular media wherein the magnetic layer is typically sputtered in the presence of inert gas, most commonly argon (Ar), deposition of a granular perpendicular magnetic layer utilizes a reactive sputtering technique wherein oxygen (O₂) is introduced, for example, in a gas mixture of Ar and O₂. Not wishing to be bound by theory, it is believed that the introduction of O₂ provides a source of oxygen that migrates into the grain boundaries forming oxides within the grain boundaries, and thereby providing a granular perpendicular structure having a reduced exchange coupling between grains. FIG. 2 shows a conventional granular perpendicular magnetic recording medium.

The process and materials used to manufacture granular perpendicular recording media produce a microstructure, which is prone to severe corrosion. To reduce overall overcoat thickness and to maintain corrosion performance, it is sometimes desirable to use cap layer in conjunction with the carbon overcoat. Cr and Ru, for example, have been proposed for use as a corrosion resistant cap layer for magnetic recording layers.

However, granular perpendicular media require a heterogeneous surface, where metal grains and oxide grain boundaries co-exist. Crystalline materials such as Cr and Ru are not as effective in covering the surface due to epitaxial growth. Accordingly, there exists a need for an improved corrosion-resistant cap layer that is effective at thin-film thicknesses.

### SUMMARY

The invention relates to magnetic recording media having an amorphous cap layer, where the amorphous cap layer protects the magnetic recording medium from corrosion.

One embodiment of the invention is a recording medium comprising a substrate, a granular magnetic layer, an amorphous cap layer, and a carbon-containing or a silicon-containing overcoat directly on the amorphous cap layer, in this order, where the amorphous cap layer protects the magnetic recording medium from corrosion.

According to one variation, the amorphous cap layer comprises a chromium alloy, preferably a ternary chromium alloy comprising a noble metal selected from the group consisting of Pt, Ru, Pd, Rh, and Ir and an element selected from the group consisting of C, P, B, and N. Preferably, the ternary chromium alloy comprises, by weight, from about 0.05% to about 0.2%, more preferably from about 0.08% to about 0.12%, of the noble metal selected from the group consisting of Pt, Ru, Pd, Rh, and Ir, and from about 12% to about 17%, more preferably from about 13% to about 15%, of the element selected from the group consisting of C, P, B, and N.

In one preferred embodiment, the amorphous cap layer comprises a ternary chromium alloy comprising Pt and C. In another preferred embodiment, the ternary chromium alloy comprises Ru and C.

In another variation, a thickness of the amorphous cap layer is between about 10 Å to about 50 Å.

Another embodiment is a method of manufacturing a magnetic recording medium comprising obtaining a substrate, depositing a granular magnetic layer, depositing an amorphous cap layer, and depositing a carbon-containing or a silicon-containing overcoat directly on the magnetic cap layer, in this order, wherein the amorphous cap layer protects the magnetic recording medium from corrosion.

Yet another embodiment is an amorphous cap layer for a magnetic recording medium.

Additional advantages of this invention will become readily apparent to those skilled in this art from the following detailed description, wherein only the preferred embodiments of the invention are shown and described, by way of illustration of the best mode contemplated for carrying out the invention. As will be realized, this invention is capable of other and different embodiments, and its details are capable of modifications in various obvious respects, all without departing from the invention. Accordingly, the drawings and description are to be regarded as illustrative in nature and not as restrictive.

### BRIEF DESCRIPTION OF THE DRAWINGS

The present invention will be better understood by reference to the Detailed Description when taken together with the attached drawings, wherein:

FIG. 1 schematically shows a magnetic disk recording medium comparing longitudinal and perpendicular magnetic recording.

FIG. 2 shows a granular perpendicular magnetic recording medium.

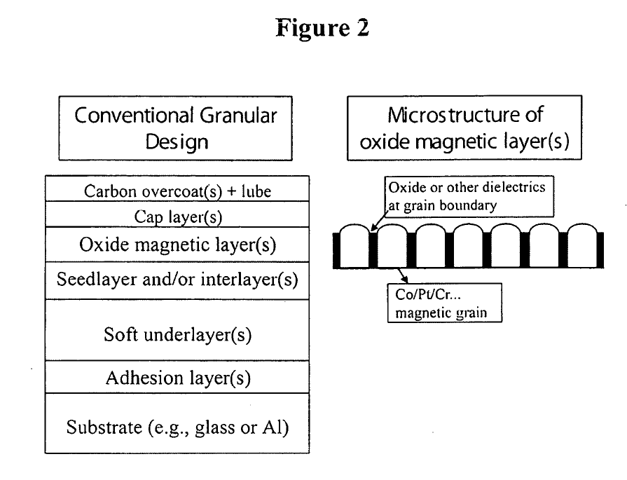

FIG. 3 shows corrosion rate and polarization resistance for Cr and CrPtC alloy films.

FIG. 4 shows potentiodynamic scans of Cr and CrPtC sputtered films.

FIG. 5 shows a perpendicular magnetic recording medium according to one aspect of the present invention.

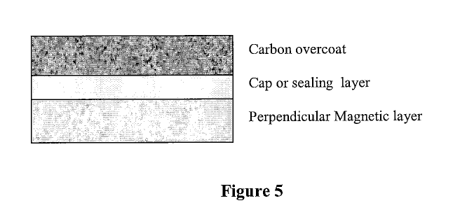

### DETAILED DESCRIPTION

This invention relates to a perpendicular magnetic recording medium having a thin, amorphous corrosion-resistant cap layer. The cap layer uniformly covers the magnetic layer surface to prevent environmental agents from accumulating and locally attacking the magnetic layer. For example, the alloy may be a ternary chromium alloy comprising a noble metal selected from the group consisting of Pt, Ru, Pd, Rh, and Ir, and an element selected from the group consisting of C, P, B, and N.

Unlike bulk alloys and thick films ≧0.1μ, for extremely thin films having a thickness in the range of 10-50 Å, a good amorphous state can be achieved with metalloid content as low as about 3%.

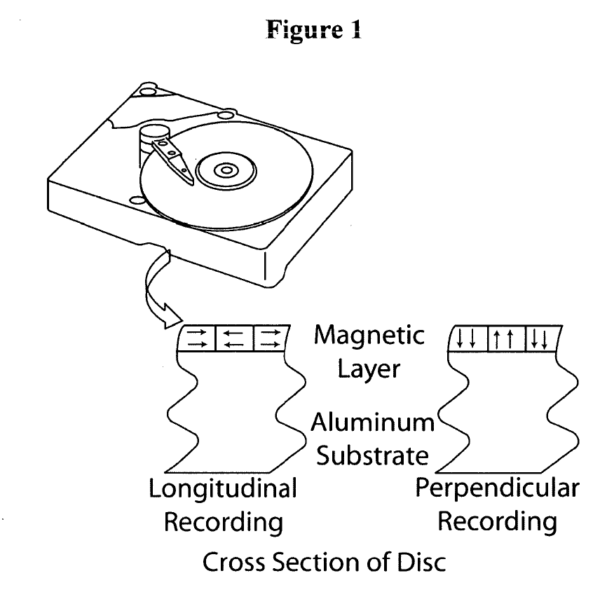

In this case, the electrochemical corrosion rate measurements were measured on ˜300 Å chromium and chromium alloy films sputtered on to NiP substrates, and the actual corrosion performance was evaluated for 10-50 Å thin cap layer of these films deposited on to perpendicular granular medium, and covered with ˜40 Å COC. The compositional range for which the best corrosion performance was obtained is for a chromium alloy with 1.4% Pt and about 10% C. The measured corrosion rate and the polarization resistance in chloride containing electrolyte for these 300 Å thick films from the linear polarization and tafel methods are given in FIG. 1. From the graph, corrosion rate for the CrPtC film is about 40% lower than only Cr containing films. This is also evidenced from the polarization resistance data shown in the graph. The polarization resistance is also about 40% higher for the CrPtC than the pure Cr films.

An embodiment of the media comprises, from the bottom to the top:

(1) Substrate: polished glass, glass ceramics, or Al/NiP.
(2) Adhesion layers to ensure strong attachment of the functional layers to the substrates. One can have more than one layer for better adhesion or skip this layer if adhesion is fine. The examples include Ti alloys.
(3) Soft underlayers (SUL) include various design types, including a single SUL, anti-ferromagnetic coupled (AFC) structure, laminated SUL, SUL with pinned layer (also called anti-ferromagnetic exchange biased layer), and so on. The examples of SUL materials include FeₓCo_{y}B_{z} based, and CoₓZr_{y}Nb_{z}/CoₓZr_{y}Ta_{z} based series.
(4) Seed layer(s) and interlayer(s) are the template for Co (00.2) growth. Examples are RuX series of materials.
(5) Oxide containing magnetic layers (M1) can be sputtered with conventional granular media targets reactively (with Oₓ) and/or non-reactively. Multiple layers can be employed to achieve desired film property and performance. Examples of targets are Co_{100-x-y}Ptₓ(MO)_{y} and/or Co_{100-x-y-z}Ptₓ(X)_{y}(MO)_{z} series (X is the 3^{id} additives such as Cr, and M is metal elements such as Si, Ti and Nb). Besides oxides in M1, the list can be easily extended such that the magnetic grains in M1 can be isolated from each other with dielectric materials at grain boundary, such as nitrides (MₓN_{y}), carbon (C) and carbides (MₓC_{y}). The examples of sputter targets are Co_{100-x-y}Ptₓ(MN)_{y}, Co_{100-x-y}Ptₓ(MC)_{y} and/or Co_{100-x-y-z}Ptₓ(X)_{y}(MN)_{z}, Co_{100-x-y-z}Ptₓ(X)_{y}(MC)_{z} series.
(6) Non-oxide containing magnetic layers (M2): The sputter targets can be used including conventional longitudinal media alloys and/or alloy perpendicular media. Desired performance will be achieved without reactive sputtering. Single layer or multiple layers can be sputtered on the top of oxide containing magnetic layers. The non-oxide magnetic layer(s) will grow epitaxially from oxide granular layer underneath. The orientation could eventually change if these layers are too thick. The examples of these are Co_{100-x-y-z-α}CrₓPt_{y}B_{z}X_{α}Y_{β}.
(7) Amorphous corrosion-resistant cap layer as described above.
(8) Conventional carbon or silicon overcoats and lubricant layers can be adapted for the embodiment of the claimed media to achieve adequate mechanical performance.

The above layered structure of an embodiment is an exemplary structure. In other embodiments, the layered structure could be different with either less or more layers than those stated above.

Instead of the optional NiP coating on the substrate, the layer on the substrate could be any Ni-containing layer such as a NiNb layer, a Cr/NiNb layer, or any other Ni-containing layer. Optionally, there could be an adhesion layer between the substrate and the Ni-containing layer. The surface of the Ni-containing layer could be optionally oxidized.

The substrates used can be Al alloy, glass, or glass-ceramic. The magnetically soft underlayers according to present invention are amorphous or nanocrystalline and can be FeCoB, FeCoC, FeCoTaZr, FeTaC, FeSi, CoZrNb, CoZrTa, etc. The seed layers and interlayer can be Cu, Ag, Au, Pt, Pd, Ru-alloy, etc. The CoPt-based magnetic recording layer can be CoPt, CoPtCr, CoPtCrTa, CoPtCrB, CoPtCrNb, CoPtTi, CoPtCrTi, CoPtCrSi, CoPtCrAl, CoPtCrZr, CoPtCrHf, CoPtCrW, CoPtCrC, CoPtCrMo, CoPtCrRu, etc., deposited under argon gas (e.g., M2), or under a gas mixture of argon and oxygen or nitrogen (e.g., M1). Dielectric materials such as oxides, carbides or nitrides can be incorporated into the target materials also.

Embodiments of this invention include the use of any of the various magnetic alloys containing Pt and Co, and other combinations of B, Cr, Co, Pt, Ni, Al, Si, Zr, Hf, W, C, Mo, Ru, Ta, Nb, O and N, in the magnetic recording layer.

In a preferred embodiment the total thickness of SUL could be 100 to 5000 Å, and more preferably 600 to 2000 Å. There could be a more than one soft under layer. The laminations of the SUL can have identical thickness or different thickness. The spacer layers between the laminations of SUL could be Ta, C, etc. with thickness between 1 and 50 Å. The thickness of the seed layer, tₛ, could be in the range of 1 Å<tₛ<50 Å. The thickness of an intermediate layer could be 10 to 500 Å, and more preferably 100 to 300 Å. The thickness of the magnetic recording layer is about 50 Å to about 300 Å, more preferably 80 to 150 Å. The adhesion enhancement layer could be Ti, TiCr, Cr etc. with thickness of 10 to 50 Å. The overcoat cap layer could be hydrogenated, nitrogenated, hybrid or other forms of carbon with thickness of 10 to 80 Å, and more preferably 20 to 60 Å.

The magnetic recording medium has a remanent coercivity of about 2000 to about 10,000 Oersted, and an Mᵣt (product of remanance, Mr, and magnetic recording layer thickness, t) of about 0.2 to about 2.0 memu/cm². In a preferred embodiment, the coercivity is about 2500 to about 9000 Oersted, more preferably in the range of about 4000 to about 8000 Oersted, and most preferably in the range of about 4000 to about 7000 Oersted. In a preferred embodiment, the Mᵣt is about 0.25 to about 1 memu/cm², more preferably in the range of about 0.4 to about 0.9 memu/cm².

Almost all the manufacturing of a disk media takes place in clean rooms where the amount of dust in the atmosphere is kept very low, and is strictly controlled and monitored. After one or more cleaning processes on a non-magnetic substrate, the substrate has an ultra-clean surface and is ready for the deposition of layers of magnetic media on the substrate. The apparatus for depositing all the layers needed for such media could be a static sputter system or a pass-by system, where all the layers except the lubricant are deposited sequentially inside a suitable vacuum environment.

Each of the layers constituting magnetic recording media of the present invention, except for a carbon overcoat and a lubricant topcoat layer, may be deposited or otherwise formed by any suitable physical vapor deposition technique (PVD), e.g., sputtering, or by a combination of PVD techniques, i.e., sputtering, vacuum evaporation, etc., with sputtering being preferred. The carbon overcoat is typically deposited with sputtering or ion beam deposition. The lubricant layer is typically provided as a topcoat by dipping of the medium into a bath containing a solution of the lubricant compound, followed by removal of excess liquid, as by wiping, or by a vapor lube deposition method in a vacuum environment.

Sputtering is perhaps the most important step in the whole process of creating recording media. There are two types of sputtering: pass-by sputtering and static sputtering. In pass-by sputtering, disks are passed inside a vacuum chamber, where they are deposited with the magnetic and non-magnetic materials that are deposited as one or more layers on the substrate when the disks are moving. Static sputtering uses smaller machines, and each disk is picked up and deposited individually when the disks are not moving. The layers on the disk of the embodiment of this invention were deposited by static sputtering in a sputter machine.

The sputtered layers are deposited in what are called bombs, which are loaded onto the sputtering machine. The bombs are vacuum chambers with targets on either side. The substrate is lifted into the bomb and is deposited with the sputtered material.

A layer of lube is preferably applied to the carbon surface as one of the topcoat layers on the disk.

Sputtering leads to some particulates formation on the post sputter disks. These particulates need to be removed to ensure that they do not lead to the scratching between the head and substrate. Once a layer of lube is applied, the substrates move to the buffing stage, where the substrate is polished while it preferentially spins around a spindle. The disk is wiped and a clean lube is evenly applied on the surface.

Subsequently, in some cases, the disk is prepared and tested for quality thorough a three-stage process. First, a burnishing head passes over the surface, removing any bumps (asperities as the technical term goes). The glide head then goes over the disk, checking for remaining bumps, if any. Finally the certifying head checks the surface for manufacturing defects and also measures the magnetic recording ability of the disk.

### EXAMPLES

The invention will be better understood with reference to the following examples, which are intended to illustrate specific embodiments within the overall scope of the invention as claimed.

### Example 1

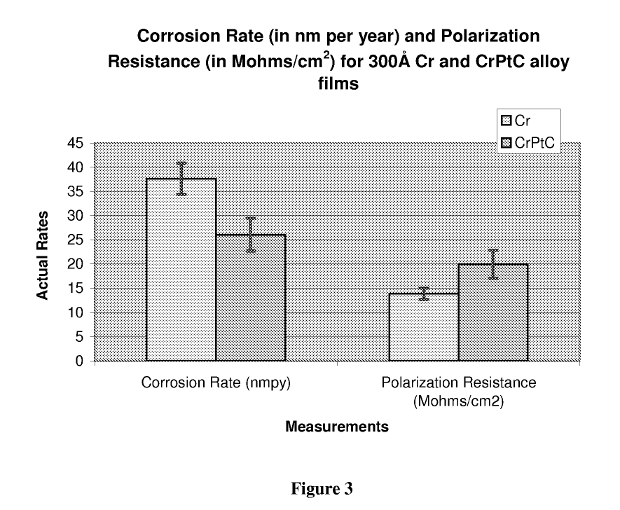

Electrochemical corrosion rate measurements were measured on ˜300 Åchromium and CrPtC alloy films sputtered onto NiP substrates, and corrosion performance was evaluated for a 10-50 Å thin cap layer of these films deposited onto perpendicular granular medium and covered with a ˜40 Å carbon overcoat. The compositional range for which the best corrosion performance was obtained was for a chromium alloy with 1.4% Pt and about 10% C. The measured corrosion rate and the polarization resistance in chloride containing electrolyte for these 300 Å thick films from the linear polarization and tafel methods are given in FIG. 3. The corrosion rate measured for the CrPtC alloy film is about 40% lower than that of the Cr-only film. The polarization resistance is also about 40% higher for the CrPtC alloy film than for the pure Cr film.

### Example 2

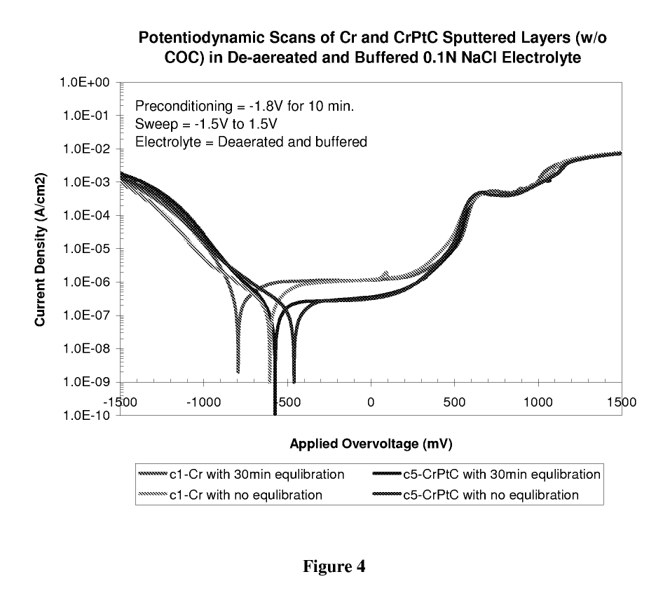

Potentiodynamic scans of ˜300 Å thick pure Cr and CrPtC alloy sputtered films were performed with and without equilibration. As shown in FIG. 4, the corrosion currents were lower for the CrPtC alloy film for a potential up to 400 mV in electrolytes containing chloride ions with and without equilibration. Also observed is that the corrosion potential for the CrPtC alloy moved to noble side compared to the pure Cr film, which also points to the improved corrosion performance.

### Example 3

CrPtC and CrRuC alloy films were deposited as cap layers on perpendicular granular media. The media design consists of CoCrPt based perpendicular magnetic media made with reactive O₂ and a variety of oxide dispersants including SiO₂ and TiO₂, on which a thin amorphous (10-50 Å) Cr alloy with trace Pt, Ru, Rh, Ir, Pd and metalloid C, P, B elements were deposited by DC or RF magnetron sputtering or plasma enhanced chemical vapor deposition (PECVD). A carbon overcoat with a thickness ranging from 10 to 50 Å was then deposited by either DC or RF magnetron sputtering or by one of the following plasma process techniques: a) plasma enhanced chemical vapor deposition (PECVD), b) ion beam deposition (IBD), and c) filtered cathodic arc deposition (FCA). The films were deposited at both ambient temperature (no heat) and at about 250° C.

The corrosion performances of these media were evaluated using the HCl vapor test. Corrosion growths were observed and counted on media exposed to a HCl vapor atmosphere for 24 hours at ambient temperature with humidity reaching 95%, using an optical tool. Corrosion performance was rated to see whether the media containing these cap layers had any haze corrosion compared to the control media having no cap layer. The media fails the test if haze is present. If no haze corrosion is present, then discrete corrosion growth or corrosion particles are counted using the counts/mm2 measurement to see whether the counts/mm2 is low enough to pass the specification.

The HCl corrosion performances of the perpendicular media containing CrPtC and CrRuC sealing layers are given in the following tables.

TABLE 1
HCl corrosion performance of perpendicular media with the cap layer
deposited at ambient temperature.
Clover Caplayer Venus Media w/ ex-situ Sox/No Heat/CrPtC or CrRuC/40 \acute{Å}
Sputter COC-24-hr HCl Test

| | | | A-side | | | B-side | | | | |
|---|---|---|---|---|---|---|---|---|---|---|
| | | Thickness | Corrosion | Counts/ | | Corrosion | Counts/ | | A-side | B-side |
| ID/Ref | Caplayers | (\acute{Å}) | Counts | mm² | Haze % | Counts | mm² | Haze % | Comments | |
| disk#2 | CrPt0.1C15 | 15 | Not | NA | NA | 201 | 1 | 0 | Disk | No haze, |
| | | | Counted | | | | | | not | and low |
| | | | | | | | | | coated | amount |
| | | | | | | | | | | of |
| | | | | | | | | | | corrosion |
| | | | | | | | | | | particles |
| disk#4 | CrPt0.1C15 | 30 | Not | ″ | ″ | 77 | 0 | 0 | Disk | No haze, |
| | | | Counted | | | | | | not | and low |
| | | | | | | | | | coated | amount |
| | | | | | | | | | | of |
| | | | | | | | | | | corrosion |
| | | | | | | | | | | particles |
| disk#6 | CrPt0.1C15 | 45 | Not | ″ | ″ | 119 | 1 | 0 | Disk | No haze, |
| | | | Counted | | | | | | not | and no |
| | | | | | | | | | coated | corrosion |
| | | | | | | | | | | particles |
| disk#2 | CrRu0.1C15 | 15 | Not | ″ | ″ | 140 | 1 | 0 | Disk | No haze, |
| | | | Counted | | | | | | not | and no |
| | | | | | | | | | coated | corrosion |
| | | | | | | | | | | particles |
| disk#4 | CrRu0.1C15 | 30 | Not | ″ | ″ | 189 | 1 | 0 | Disk | No haze, |
| | | | Counted | | | | | | not | and no |
| | | | | | | | | | coated | corrosion |
| | | | | | | | | | | particles |
| disk#6 | CrRu0.1C15 | 45 | Not | ″ | ″ | 672 | 4 | 0 | Disk | No haze, |
| | | | Counted | | | | | | not | and no |
| | | | | | | | | | coated | corrosion |
| | | | | | | | | | | particles |
| Control | No | 0 | Not | ″ | ″ | | 0 | 100 | Disk | 100% |
| | | | Counted | | | | | | not | haze w/ |
| | | | | | | | | | coated | blue tint |

TABLE 2
HCl corrosion performance of perpendicular media with the cap layer
deposited at about 250° C.
Clover Caplayer Venus Media w/ ex-situ Sox/250° C./CrPtC or CrRuC40 \acute{Å}
Sputter COC-24-hr HCl Test

| | | | A-side | | | B-side | | | | |
|---|---|---|---|---|---|---|---|---|---|---|
| | | Thickness | Corrosion | Counts/ | | Corrosion | Counts/ | | A-side | B-side |
| ID/Ref | Caplayers | (\acute{Å}) | Counts | mm² | Haze % | Counts | mm² | Haze % | Comments | |
| disk#1 | CrPt0.1C15 | 15 | Not | NA | NA | 86 | 0 | 0 | Disk | Discrete |
| | | | Counted | | | | | | not | corrosion |
| | | | | | | | | | coated | particles |
| disk#3 | CrPt0.1C15 | 30 | Not | ″ | ″ | 17 | 0 | 0 | Disk | Discrete |
| | | | Counted | | | | | | not | corrosion |
| | | | | | | | | | coated | particles |
| disk#5 | CrPt0.1C15 | 45 | Not | ″ | ″ | 58 | 0 | 0 | Disk | Discrete |
| | | | Counted | | | | | | not | corrosion |
| | | | | | | | | | coated | particles |
| disk#7 | CrRu0.1C15 | 15 | Not | ″ | ″ | 150 | 1 | 0 | Disk | Discrete |
| | | | Counted | | | | | | not | corrosion |
| | | | | | | | | | coated | particles |
| disk#9 | CrRu0.1C15 | 30 | Not | ″ | ″ | 218 | 1 | 0 | Disk | Discrete |
| | | | Counted | | | | | | not | corrosion |
| | | | | | | | | | coated | particles |
| disk#11 | CrRu0.1C15 | 45 | Not | ″ | ″ | 55 | 0 | 0 | Disk | Discrete |
| | | | Counted | | | | | | not | corrosion |
| | | | | | | | | | coated | particles |

No haze corrosion was observed for the media with the cap layer and 40 Å sputtered carbon overcoat, and the discrete corrosion counts were low (0-1 counts/mm2 in most cases). However, the media without the cap layer (control) showed 100% haze corrosion after the HCl corrosion test. The results demonstrate that deposition of thin 10-50 Å CrPtC and CrRuC cap layers at either ambient temperature or 250° C. can prevent haze corrosion from occurring and reduce discrete corrosion counts to a low number.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

What is claimed is:

1. A magnetic recording medium comprising a substrate, a granular magnetic layer, an amorphous cap layer, and a carbon-containing or a silicon-containing overcoat directly on the amorphous cap layer, in this order, wherein the amorphous cap layer protects the magnetic recording medium from corrosion.

2. The magnetic recording medium of claim 1, wherein the amorphous cap layer comprises a chromium alloy.

3. The magnetic recording medium of claim 1, wherein the amorphous cap layer comprises a ternary chromium alloy comprising a noble metal selected from the group consisting of Pt, Ru, Pd, Rh, and Ir and an element selected from the group consisting of C, P, B, and N.

4. The magnetic recording medium of claim 3, wherein the ternary chromium alloy comprises Pt and C.

5. The magnetic recording medium of claim 3, wherein the chromium alloy comprises Ru and C.

6. The magnetic recording medium of claim 3, wherein the ternary chromium alloy comprises, by weight, from about 0.05% to about 0.2% of the noble metal selected from the group consisting of Pt, Ru, Pd, Rh, and Ir, and from about 12% to about 17% of the element selected from the group consisting of C, P, B, and N.

7. The magnetic recording medium of claim 3, wherein the ternary chromium alloy comprises, by weight, from about 0.08% to about 0.12% of the noble metal selected from the group consisting of Pt, Ru, Pd, Rh, and Ir, and from about 13% to about 15% of the element selected from the group consisting of C, P, B, and N.

8. The magnetic recording medium of claim 3, wherein a thickness of the amorphous cap layer is between about 10 Åto about 50 Å.

9. A method of manufacturing a magnetic recording medium comprising obtaining a substrate, depositing a granular magnetic layer, depositing an amorphous cap layer, and depositing a carbon-containing or a silicon-containing overcoat directly on the magnetic cap layer, in this order, wherein the amorphous cap layer protects the magnetic recording medium from corrosion.

10. The method of claim 9, wherein the amorphous cap layer comprises a ternary chromium alloy comprising a noble metal selected from the group consisting of Pt, Ru, Pd, Rh, and Ir and an element selected from the group consisting of C, P, B, and N.

11. The method of claim 10, wherein the ternary chromium alloy comprises Pt and C.

12. The method of claim 10, wherein the ternary chromium alloy comprises Ru and C.

13. The method of claim 10, wherein the ternary chromium alloy comprises, by weight, from about 0.05% to about 0.2% of the noble metal selected from the group consisting of Pt, Ru, Pd, Rh, and Ir, and from about 12% to about 17% of the element selected from the group consisting of C, P, B, and N.

14. The method of claim 10, wherein the ternary chromium alloy comprises, by weight, from about 0.08% to about 0.12% of the noble metal selected from the group consisting of Pt, Ru, Pd, Rh, and Ir, and from about 13% to about 15% of the element selected from the group consisting of C, P, B, and N.

15. The method of claim 10, wherein a thickness of the amorphous cap layer is between about 10 Åto about 50 Å.

16. An amorphous cap layer for a magnetic recording medium comprising a ternary chromium alloy.

17. The amorphous cap layer of claim 16, wherein the ternary chromium alloy comprises a noble metal selected from the group consisting of Pt, Ru, Pd, Rh, and Ir and an element selected from the group consisting of C, P, B, and N.

18. The amorphous cap layer of claim 17, wherein the ternary chromium alloy comprises, by weight, from about 0.05% to about 0.2% of the noble metal selected from the group consisting of Pt, Ru, Pd, Rh, and Ir, and from about 12% to about 17% of the element selected from the group consisting of C, P, B, and N.

19. The amorphous cap layer of claim 17, wherein the ternary chromium alloy comprises, by weight, from about 0.08% to about 0.12% of at least one noble metal selected from the group consisting of Pt, Ru, Pd, Rh, and Ir, and from about 13% to about 15% of at least one element selected from the group consisting of C, P, B, and N.

20. The amorphous cap layer of claim 17, wherein a thickness of the amorphous cap layer is between about 10 Åto about 50 Å.
